(19) United States
(12) Patent Application Publication
(10) Pub. No.: US 2007/0038883 A1
(43) Pub. Date: Feb. 15, 2007

(54) MOUNTING SYSTEM FOR MEDICAL SENSORS

(75) Inventors: Henning GERDER, Lübeck (DE); Jorg-Uwe MEYER, Ratzeburg (DE)

Correspondence Address: MCGLEW & TUTTLE, PC, P.O. BOX 9227, SCARBOROUGH STATION, SCARBOROUGH, NY, 10510-9227, US

(73) Assignee: DRAGER MEDICAL AG & CO. KG, Lubeck (DE)

(21) Appl. No.: 11/458,441

(22) Filed: Jul. 19, 2006

(30) Foreign Application Priority Data
Aug. 12, 2005 (DE) 10 2005 038 148.0

(51) Int. Cl. G06F 11/00

(52) U.S. Cl. 714/4

(57) ABSTRACT

A mounting system for medical sensors is provided including an interface (2) for the electric contacting of a sensor (1). System components (3, 4, 5, 6, 7, 8) for processing the sensor signals are provided as well as an electromagnetic transmission unit (9) with an antenna (12). The system components (3, 4, 5, 6, 7, 8) and the transmission unit (9) are supplied by a power source (10).

### CROSS REFERENCE TO RELATED APPLICATIONS

This application claims the benefit of priority under 35 U.S.C. § 119 of German Patent Application DE 10 2005 038 148.0 filed Aug. 12, 2005, the entire contents of which are incorporated herein by reference.

### Field of the Invention

The present invention pertains to a mounting system for medical sensors.

### BACKGROUND OF THE INVENTION

The use and the application of medical sensors, such as especially electrocardiogram (ECG) sensors on the human body with wire connection has decisive drawbacks in terms of handling compared to a wireless connection. The electric supply lines are disadvantageous in clinical practice because they make access to the patient difficult and they often must be removed and subsequently reconnected before and after the transportation of the patient. Besides ECG sensors, other sensors for detecting physiological measured variables, for example, temperature sensors, capacitive moisture sensors, transcutaneous oxygen or carbon dioxide sensors, pulse or blood pressure sensors and other sensors, are also arranged on the patient's skin. The same drawbacks are true of such sensors with wire connection and electric supply cables as of ECG sensors.

Chest belts for pulse measurement, which may also be combined with pieces of clothing in the form of inserted pockets, are known for the application of wireless sensor systems on the body.

### SUMMARY OF THE INVENTION

The object of the present invention is to provide a mounting system for different medical sensors with integrated signal processing and with a wireless transmission means for transmission to an evaluating unit.

According to the invention, a mounting system is provided for medical sensors with an interface for making electric contact with a sensor. System components are provided for processing sensor signals. The system has an electromagnetic transmission unit with an antenna. The system components and the transmission unit are supplied by a power source.

The design described comprises system components that can be assembled in a sandwich-like manner. As a result, sensors that can be used once can be connected both to electronic units that can be used once and to batteries that can be used once and to reusable electronic units and to batteries that can be used several times.

The system components are combined with one another via a plug system, which is designed like a “bus” and thus permits a freely selectable order of plugging in the system components. The order of plugging in and the arrangement in space of the system components can thus be selected according to the physical, metrological and geometric requirements. Sensor-specific adaptation modules are used for the electrically conductive connection of the sensor connection wires to connect the wired sensors introduced in practice, which can generally be used once, and to mount them in the existing mounting system.

The following examples of sensors can be combined with the mounting system, but the listing is not complete: resistive or digital skin or body temperature sensors, capacitive or digital moisture sensors, single-electrode or multi-electrode sensors for ECG measurement, microphones or pressure transducers for the diagnosis of labor and heart sounds, transcutaneous oxygen and carbon dioxide sensors, sensors for pulse oximetry and pulse measurement, sensors for plethysmography as well as sensors for noninvasive blood pressure measurement.

The system components may be used to process the sensor signals for signal amplification, filtration, conversion, value correction and/or coding.

The power source is advantageously rechargeable and is connected to a battery charging system, especially with inductive coupling.

The sensor may advantageously be a temperature or moisture sensor or an ECG electrode.

The system components may advantageously be modularly connected to one another and to the transmission unit with the antenna and with the power source. The system components, the transmission unit with the antenna and the power source may advantageously be connected by means of plug type connectors.

An exemplary embodiment of the present invention will be explained below on the basis of the figures. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a schematic view of the connection of the different system components; and

FIG. 2 is a three-dimensional exploded view of a sandwich structure of a mounting system for medical sensors.

### DESCRIPTION OF THE PREFERRED EMBODIMENTS

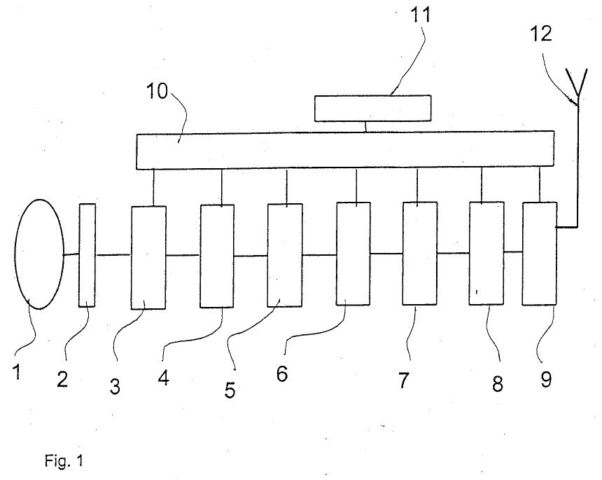

Referring to the drawings in particular, the individual system components forming the mounting system for medical sensors are shown in FIG. 1.

The sensor 1 is, for example, a resistive temperature sensor with a negative temperature coefficient, which is known per se. The interface 2 of the mounting system is used for the adaptation of the sensor, for example, by means of a two-lead clamped connection. The operating electronic unit 3 is, for example, a precision power source. Other system components are, for example, a signal amplification and analog filtration unit 4, a signal conversion element 5 such as a series-connected 16-bit A/D converter 5, a signal detection device 6, for example, a microcontroller 6, a further signal processing element 7, for example, a value correction unit or temperature calculation unit 7, a signal processing element 8, for example, a special coding element 8, and an electromagnetic transmission unit 9 with an antenna 12 for the transmission of the signals to an evaluating unit.

The individual system components are supplied by means of an electric power source 10, which is especially a battery pack, with a corresponding battery charging system 11, for example, with inductive coupling.

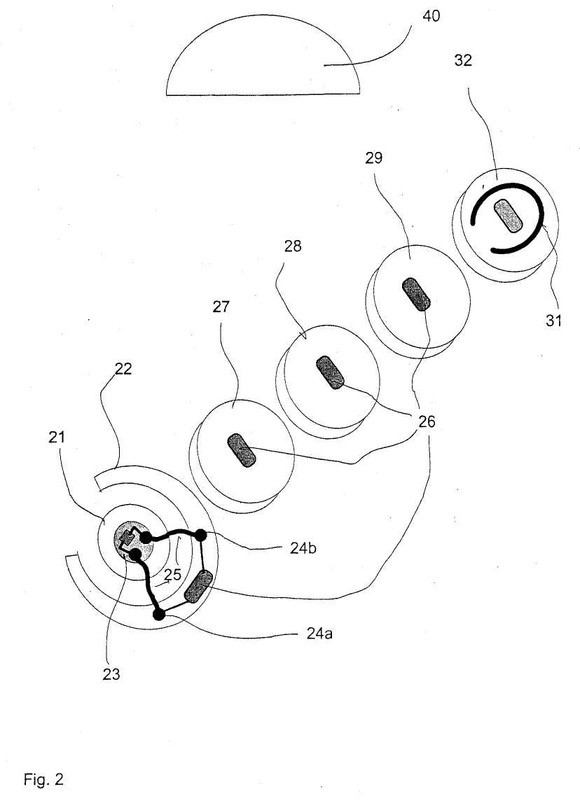

FIG. 2 shows the sandwich structure of a mounting system for medical sensors as will be described below:

An inner bond pad 21 with a flat sensor 23 and short supply wires 25 is used, for example, to detect the temperature or moisture of the skin or as an ECG electrode. The outer mounting plane 22 is used as a sensor connection with clamping contacts 24a and 24b. The plug type connectors 26 are used for the intermodular connection of the system components as follows: 27 contains the operating electronic unit, here integrated with signal amplification, filtration and conversion, 28 is the battery supply, for example, by a battery, 29 is used for the signal detection and coding, 31 is the antenna, and 32 is the electromagnetic transmission unit. Finally, all system components are covered with a shell-shaped cover 40.

While specific embodiments of the invention have been shown and described in detail to illustrate the application of the principles of the invention, it will be understood that the invention may be embodied otherwise without departing from such principles.

What is claimed is:

1. A mounting system for medical sensors, the mounting system comprising:
a sensor;
an interface for electrical contact with said sensor;
system components for processing sensor signals;
an electromagnetic transmission unit with an antenna; and
a power source for supplying the system components and the transmission unit with power.

2. A mounting system in accordance with claim 1, wherein said system components are used to process the sensor signals for signal amplification, filtration, conversion, value correction and/or coding.

3. A mounting system in accordance with claim 1, wherein said power source is rechargeable and is connected to a battery charging system with inductive coupling.

4. A mounting system in accordance with claim 1, wherein said sensor is a temperature or moisture sensor or an ECG electrode.

5. A mounting system in accordance with claim 1, wherein said system components are modularly connected to one another and to said transmission unit antenna and with said power source.

6. A mounting system in accordance with claim 5, wherein said system components, said transmission unit with antenna and said power source are connected by means of plug type connectors.

7. A mounting system for medical sensors, the mounting system comprising:
a sensor;
a sensor connection mounting surface, said sensor connection mounting surface having clamping contacts;
an interface for electrical contact with said sensor;
system components for processing sensor signals;
an electromagnetic transmission unit with an antenna; and
a power source for supplying the system components and the transmission unit with power.

8. A mounting system in accordance with claim 7, wherein said sensor is mounted on a bonding pad.

9. A mounting system in accordance with claim 7, wherein supply wires connect from said sensor to said clamping contacts on said sensor connection mounting surface.

10. A mounting system in accordance with claim 7, wherein said sensor is a temperature or moisture sensor or an ECG electrode.

11. A mounting system in accordance with claim 7, wherein said system components comprises an electronic unit to process said sensor signals for signal amplification, filtration, and conversion.

12. A mounting system in accordance with claim 7, wherein said power source is a rechargeable battery, said rechargeable battery being recharged when connected to a battery charging system with inductive coupling.

13. A mounting system in accordance with claim 7, wherein said system components comprises a unit for signal detection and coding.

14. A mounting system in accordance with claim 7, wherein said system components are intermodularly connected to one another and to said electromagnetic transmission unit with an antenna and with the power source.

15. A mounting system in accordance with claim 7, wherein said system components, said transmission unit with the antenna and said power source are connected by means of plug type connectors.

16. A mounting system in accordance with claim 7, wherein a plug type connector is mounted on said sensor connection mounting surface, said plug type connector is connected to said clamping contacts on said sensor connection mounting surface.

17. A mounting system in accordance with claim 7, wherein said electromagnetic transmission unit with the antenna wirelessly transmits said sensor signals to an evaluating unit.

18. A mounting system in accordance with claim 7, wherein a covering shell covers said system components.
